(19) United States
(12) Patent Application Publication
(10) Pub. No.: US 2012/0044697 A1
(43) Pub. Date: Feb. 23, 2012

(54) Incandescent bulb and light source apparatus

(75) Inventors: Yutaka Yamamizu, Hyogo (JP); Shinobu Muraki, Hyogo (JP); Satoshi Ono, Hyogo (JP)

(73) Assignee: USHIO DENKI KABUSHIKI KAISHA, Chiyoda-ku, Tokyo (JP)

(21) Appl. No.: 13/138,949

(22) PCT Filed: May 20, 2010
(86) PCT No.: PCT/JP2010/058510

§ 371 Date: Oct. 28, 2011

(30) Foreign Application Priority Data
May 29, 2009 (JP) 2009-130179

(51) Int. Cl. F21V 7/00; H01K 1/14

(52) U.S. Cl. 362/296.09; 313/315

(57) ABSTRACT

An object of this invention is to provide an incandescent bulb which has sufficiently high brightness and produces a god light distribution on a surface irradiated by the light, and a light source apparatus having high usage efficiency of the light radiated from the incandescent light bulb. The incandescent light bulb is provided therein with a filament that includes a plurality of filament segments made from a single coil formed by winding one wire material that respectively extend along an axial direction of the bulb and are arranged in parallel to form a flat surface, wherein a pitch of the plurality of filament segments located at a central part of the bulb is smaller than a pitch of a plurality of filament segments located at both side portions.

### TECHNICAL FIELD

The present invention relates to an incandescent bulb, which is used as, for example, a light source for studio lighting, and a light source apparatus equipped with the incandescent bulb.

### BACKGROUND

For example, a large output type incandescent bulb, which is mainly used for studio lighting and the like, is combined with an appropriate lens and a reflection mirror, and may be used as a spotlight light source for a stage or the like. A certain type of such incandescent bulb is configured so that a filament formed in a flat shape is arranged in, for example, a quartz glass bulb, where one end of which is sealed. A plurality of filament segments, each of which is formed by winding tungsten wire material in a shape of a coil, are arranged in parallel to one another along with the tube axis of the bulb (see, for example, Patent literature 1). Since an input of such a planar light emitting incandescent bulb can be made higher than that of the structure, which is arranged so that a single coil filament extends in a form of a line, it serves as a bright light source.

### PRIOR ART REFERENCE

### Patent Literature

Patent Literature 1: Japanese Patent Application Publication No. 2001-319624.

### SUMMARY OF THE INVENTION

### Problems That the Invention to Solve

In case where an incandescent bulb having the structure described above is used as alight source for spotlight, it is desired that an incandescent bulb have sufficiently high illuminance and a good light distribution (illuminance characteristics) on an illuminated field (light irradiation face).

To meet such a need, for example, a filament is configured as a double coil, which is formed by further winding a single coil filament in the shape of a coil, thereby increasing the input to the filament and improving the incandescent bulb's intensity. However, the filament having such structure is weak against impacts, such as mechanical vibrations, and tends to deform or disconnect.

Hence the present inventors considered installing an incandescent bulb having the structure described above into a lamp fitting in which a general condensing mirror was used, alight source apparatus as shown in FIG. 4 was made as a trial.

A light source apparatus 40 comprises an incandescent bulb 41 having a filament 42, in which a plurality of filament segments 42A made from a single coil filament, are arranged in a flat shape and in parallel to one another; a lens 45, which is arranged at a front side position of the incandescent bulb 41 in a lighting direction (which is a left side direction and is shown in an outline arrow in FIG. 4); and a reflection mirror 48, which is arranged at a back side position of the incandescent bulb 41 with respect to the lighting direction. The light emitted from the incandescent bulb 41 is directly emitted or is reflected towards the front side by the reflection mirror 48 arranged on the back side of the incandescent bulb 41 to be emitted, through the lens 45.

In the Incandescent bulb 41, each of the plurality of filament segments 42A is arranged in a direction extending along with a tube axis C2 of the bulb (the central axis of the incandescent bulb), i.e. so as to extend in a direction perpendicular to the lighting direction, and while the central axis L2 of the lens (optical axis) and the central axis L3 of the reflection mirror (optical axis) are in agreement with each other, they bisect the filament segment 42A in the incandescent bulb 41 (the central axis C2 of the incandescent bulb) at right angles. A reference number 44 in FIG. 4 denotes a mouthpiece insulator that is attached to one end of the bulb 43 by, for example, an adhesive agent and that is made from, for example, ceramics.

However, it was found that the light source apparatus 40 having such a structure cannot be configured to meet the required illuminance characteristics.

The present invention was made in view of the above circumstances, and an object thereof is to offer an incandescent bulb in which sufficiently high illuminance and a good light distribution on a light irradiation face can be obtained.

Moreover, it is another object of the present invention to provide a light source apparatus having the above-mentioned incandescent bulb that emits high usage efficiency light.

### Means to Solve Problems

An incandescent bulb of this invention has a filament constructed from a plurality of filament segments that are made from a single coil formed by winding one wire material that respectively extend along an axial direction of a bulb and are arranged in parallel to form a flat surface, characterized in that a pitch of a plurality of filament segments located at a central part of the bulb is smaller than a pitch of a plurality of filament segments located at a first side portion and a second side portion.

Further, a length of a filament formation area in a direction perpendicular to an axial direction of the incandescent bulb of the present invention may preferably be 90% or less of an inner diameter of the incandescent bulb.

Furthermore, a ratio (H/W) of a length W of the filament formation area in the axial direction of the incandescent bulb of the present invention to a length H of the filament formation area in a direction perpendicular to the axial direction of the incandescent bulb may preferably be 0.5 or more.

Moreover, a light source apparatus of the present invention includes the incandescent bulb and a condensing mirror, characterized in that the incandescent bulb is arranged in a direction extending along with a central axis of the condensing mirror so that two of the filament segments located at the central part of the bulb are located to sandwich the central axis of the condensing mirror.

### Advantageous Effect of the Invention

According to the incandescent bulb of the present invention, since the plurality of filament segments made from a single coil filament is arranged in a flat shape and in parallel to one another, the effective surface area of the filament (an area from which light is emitted) can be enlarged so that high light irradiation ratio can be obtained as a whole from the filament, and in addition, since the pitch of the filament segments located at the central part of the bulb and that of the filament segments located at the both side parts are set to be different from each other so that the illuminance of light from a portion near a central portion of the filament, which is located at the central part of the bulb, may be made relatively higher than that of light from end portions, which are located at both side parts of the bulb, it is possible to obtain the illuminance characteristics having intensity distribution, which are close to those of a point light source, in which the illuminance of a central part of the light irradiation face is high and that therearound is low.

Moreover, since the length of the filament formation area in a direction perpendicular to the axial direction of the bulb is set 90% or less of the inner diameter of the bulb, it can be brought into a state where the filament is not too close to the bulb, so that it is possible to prevent the temperature of the bulb from rising locally at time of lighting, whereby a predetermined halogen cycle can be obtained certainly. Furthermore, since the filament can be configured in an approximately square and flat surface shape by making the length of the filament formation area in the axial direction of the bulb, suitable in size, a light distribution having an approximately circular shape can be obtained on the light irradiation face, whereby it is possible to obtain the illuminance characteristics near a point light source.

According to the light source apparatus of this invention, since a condensing point of the condensing mirror is formed to be located within an area of the filament of the incandescent bulb, from which the highest illuminance light is emitted and in which the two filament segments located at the central part of the bulb are located, while the illuminance characteristics close to those of a point light source can be obtain on the light irradiation face, the usage efficiency of light emitted from the incandescent bulb can be made high.

### BRIEF DESCRIPTION OF DRAWINGS

FIG. 1 is an explanatory diagram showing a schematic structure of an example of a light source apparatus.

FIG. 2 is an explanatory diagram showing a schematic main part of an example of an incandescent bulb.

FIG. 3 is a partially enlarged explanatory diagram of part of a filament of the incandescent bulb shown in FIG. 2.

FIG. 4 is an explanatory diagram showing a schematic structure of an example of a light source apparatus, which is experimentally made by using an incandescent bulb having a filament, wherein the filament is formed by arranging a plurality of filament segments in a flat shape and in parallel to one another.

### Embodiments FOR CARRYING OUT THE INVENTION

Description of an embodiment will be given in detail.

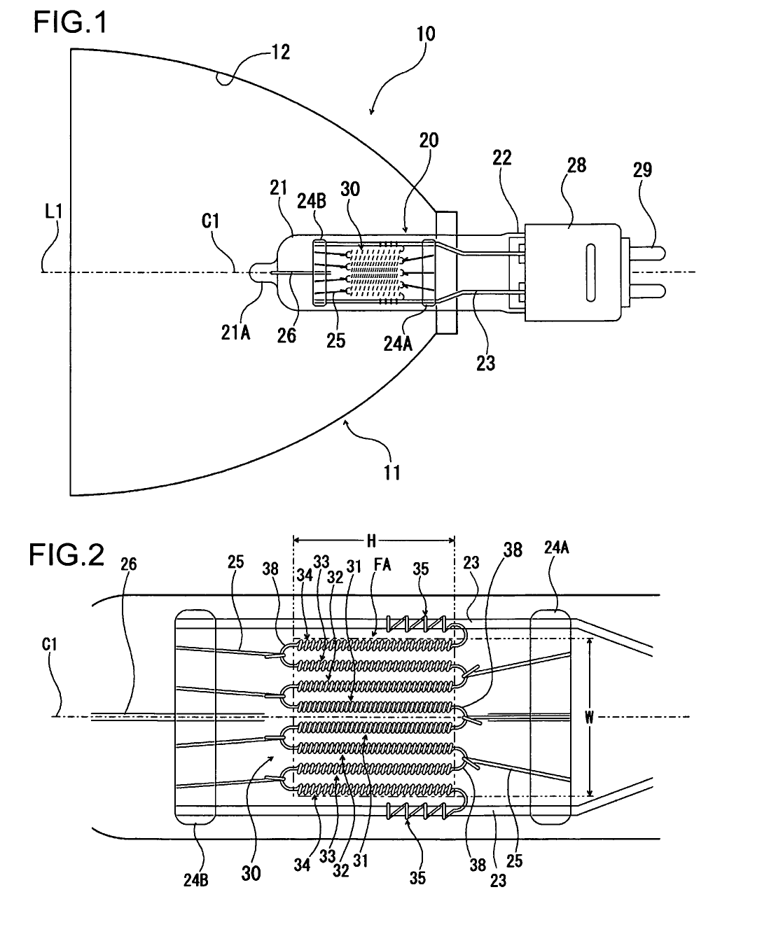

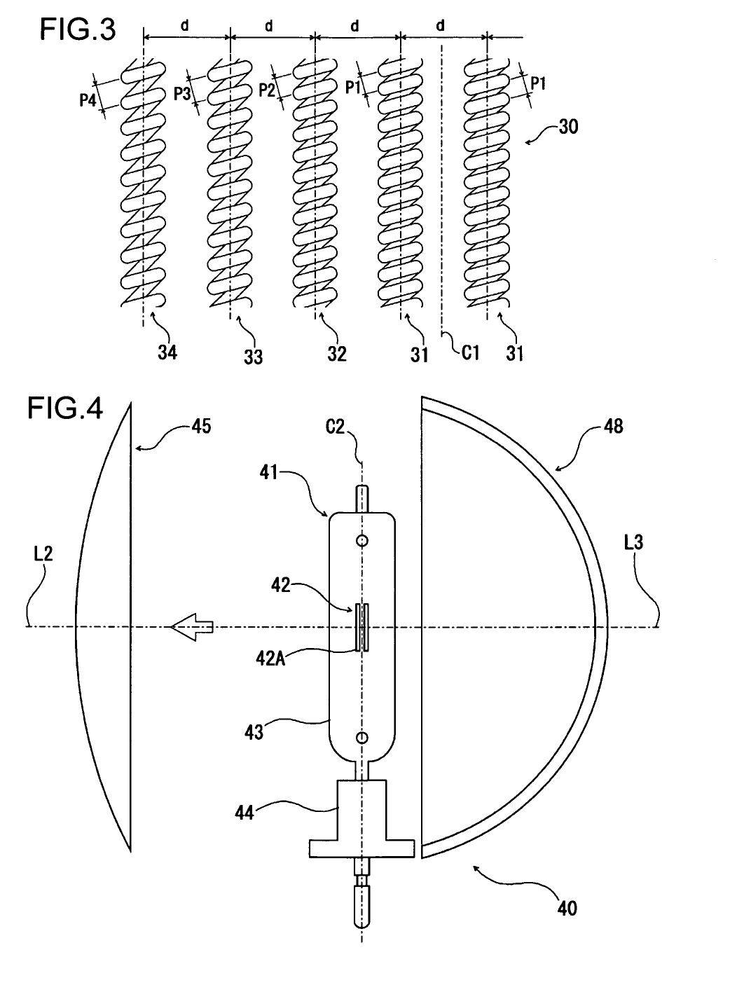

FIG. 1 shows an explanatory diagram showing a schematic structure of an example of a light source apparatus, FIG. 2 is an explanatory diagram showing a schematic main part of an example of an incandescent bulb, and FIG. 3 is a partially enlarged explanatory diagram of part of a filament of the incandescent bulb shown in FIG. 2.

This light source apparatus 10 is configured so that an incandescent bulb 20 is held in and fixed to a condensing mirror 11 in a position where the tube axis C1 of the bulb (the central axis of the incandescent bulb) is in agreement with the central axis L1 of the condensing mirror (optical axis). The condensing mirror 11 is made up of an ellipsoidal collecting mirror or a paraboloidal condensing mirror that has an approximately quadric surface of revolution as a whole.

The condensing mirror 11 is made from heat resisting glass, for example, borosilicate glass and alumina silicate glass or the like. A reflector 12 is provided by forming a dielectric multilayer film on an inner surface thereof.

The incandescent bulb 20 is a one end sealing type, in which a cylindrical bulb 21 made of, for example, quartz glass, is provided, at one end of which a sealing portion 22 is formed by sealing and at the other end of which an exhaust pipe remaining portion 21A is provided. A filament 30 is arranged in the bulb 21, wherein the filament is formed by winding a wire material, made of, for example, tungsten in a shape of a coil.

A mouthpiece insulator 28, which has a cylindrical shape with a bottom, and which is made from, for example, ceramics or metal, is attached to the sealing portion 22 of the bulb 21 by an adhesive agent. A reference number 29 denotes a metal connection terminal, which is led out outward in an axial direction from the bottom portion of the mouthpiece insulator 28.

The filament 30 is formed so that the central axis of each of a plurality of filament segments, which is made from a single coil, extends approximately parallel to the tube axis C1 of the bulb, that is, extends along the axis direction of the bulb 21, and they are arranged in a flat surface shape (two-dimensionally) and in parallel to one another so that they are located on the same flat face.

The filament 30 in this embodiment is made up of eight filament segments. Two filament segments 31, which are located at a central part of the bulb 21 (hereinafter referred to as “middle segments”), are connected to each other at respective ends through a single wire section (a connecting portion) 38, which curves in an arc shape. The other end of each filament segment 31 is connected through a single wire portion 38 to the other end of a filament segment 32 (hereinafter referred to as an “inner side intermediate segment”), which is located next to the middle segment 31. One end of each inner side intermediate segment 32 is connected, through a single wire section 38, to one end of a filament segment 33 (hereinafter referred to as a “outer side intermediate segment”) which is located next to the inner side intermediate segment 32. The other end of the outer side intermediate segment 33 is connected, through a single wire section 38, to the other end of a filament segment 34 (hereinafter referred to as an “end portion segment”), which is located next to the outer side intermediate segment 33 and at both side portions of the bulb 21. A coil shape connecting portion 35 is formed on the one end of each end portion segment 34.

The filament 30 is provided in the bulb 21, so that each of the connecting portions 35 of the both ends is connected and fixed to an internal lead 23 in a state where the internal rod shape lead 23, which extends along with the tube axis C1 of the bulb, is inserted in the inside. The single wire sections 38 of the filament 30 are engaged with respective anchors 25, which are buried in and fixed to a first glass piece 24A or a second glass piece 24B. Wherein, the first and second glass pieces are provided apart from each other in an axial direction in the bulb 21.

While the other end portion and an intermediate portion of the pair of internal leads 23 are respectively buried in and fixed to the first glass piece 24A and the second glass piece 24B, one end portion thereof, which is electrically connected to a connection terminal 29 of the mouthpiece insulator 28, is buried in and fixed to the sealing portion 22. In addition, a structural material, which is denoted as a reference number 26 in FIG. 2, is a supporter, and both end side portions thereof are respectively buried in and fixed to the first glass piece 24A and the second glass piece 24B.

And, as shown in FIG. 3, in the filament 30 of the above-mentioned incandescent bulb 20, a total of eight filament segments, that is, the two middle segments 31, the two inner side intermediate segments 32, the two outer side intermediate segments 33, and the two end portion segments 34, are provided to be apart at equal intervals with respect to a direction perpendicular to the tube axis C1 of the bulb. That is, so that distances d between central axes, each of which adjoins to each other, are equal to one another, wherein the two middle segments 31 are arranged to sandwich the tube axis C1 of the bulb, and the pitch of the middle segments 31, that of the inner side intermediate segments 32, that of the outer side intermediate segments 33, and that of the end portion segments 34 are different from one another.

In this embodiment, a pitch P1 of the middle segments 31 located at the central part of the bulb 21, a pitch P2 of the inner side intermediate segments 32, a pitch P3 of the outer side intermediate segments 33, and a pitch P4 of the end portion segments 34 located at the both ends of the bulb 21 are set to satisfy relationship of P1<P2<P3<P4. The pitch P1 of the two middle segments 31 located at the central part of the bulb 21 is set the smallest, and the farther the filament segments are from the central part of the bulb 21 in a diameter direction toward the outside, the greater the pitch thereof is set.

While the pitch P1 of the middle segments 31 located at the central part of the bulb 21 among the plurality of the filament segments is small (the coil pitch is set relatively dense), the pitch P4 of the end portion segment 34 located at the both side portions of the bulb 21 (density of the coil pitch is set relatively low) is large. Since the illuminance of light emitted from the central part of the entire filament 30 can be set relatively higher than that of light emitted from the both side portions thereof, it is possible to obtain the illuminance characteristics close to those of a point light source having an approximately circular shape light distribution on the light irradiation face, in which a illuminance of the central part of the light irradiation face is high and an illuminance therearound is low.

It is desirable that a relative value of the pitch of each filament segment be set within a range of, for example, 135-180%, wherein the pitch is taken as 100% when the size of the clearance (gap) between adjoining wires is 0.

Moreover, it is desirable that the pitches of the inner side intermediate segment 32, the outer side intermediate segment 33, and the end portion segments 34 be respectively set so that pitch ratios of the pitch P1 of the middle segment 31 to the pitch of the inner side intermediate segment 32, that of the outer side intermediate segment 33, and that of the end portion segment 34 (pitch ratio; P1/P2, P1/P3 and P1/P4) are 70% or more.

In the above-mentioned incandescent bulb 20, it is desirable that a filament formation area (an area surrounded by two-dot chain lines in FIG. 2) FA, where the plurality of the filament segments are arranged in a flat shape and in parallel to one another, be configured so that the length (size) W in a direction perpendicular to the axial direction of the bulb 21 is 90% or less of the size of the inner diameter of the bulb 21, and it is desirable that the ratio (H/W) of the length H (size) of the filament formation area FA in the axial direction of the bulb 21, to the length W thereof in a direction perpendicular to the axial direction of the bulb 21 be set within a range of 0.5 or more.

In the incandescent bulb 20, when the length W of the filament formation area FA in the direction perpendicular to the axial direction of the bulb 21 and the length H thereof in the axial direction of the bulb 21 are set within the above mentioned ranges and since the formation area FA of the filament 30 has an approximately square and flat shape, a light distribution having an approximately circular shape can be certainly obtained on the light irradiation face, so that it is possible to obtain the illuminance characteristics close to those of a point light source. On the other hand, in case where that of the filament formation area FA in the axial direction of the bulb 21 or a direction perpendicular thereto is too large with respect to the other, a light distribution having an approximately circular shape cannot be certainly obtained on the light irradiation face. Thus, it is difficult to obtain the desirable illuminance characteristics.

As mentioned above, the light source apparatus 10 according to the present invention is configured so that the incandescent bulb 20 having the above mentioned structure is held in and fixed to the condensing mirror 11, in a position where the tube axis C1 of the bulb is in agreement with the central axis L1 of the condensing mirror.

That is, in the incandescent bulb 20, the two middle segments 31 of the filament 30 located at the central part of the bulb 21, in which the pitch thereof is smaller than those of the other the filament segments, are located to sandwich the central axis L1 of the condensing mirror, so that the condensing point of the condensing mirror 11 (a position on the central axis L1) is formed to be located in an area of the filament 30 within the incandescent bulb 20, which is irradiated with the highest illuminance light.

According to the incandescent bulb 20 of the above-mentioned structure, since the filament 30 is formed so that the plurality of the filament segments, which are respectively made from a single coil, are arranged in a flat shape and in parallel to one another, the effective surface area of the filament 30 (an area from which light is emitted) is enlarged so that the high light irradiation ratio is obtained as a whole in the filament 30. In addition, while the pitch P1 of the middle segments 31 of the bulb 21 is set to the smallest value so that the illuminance of light from the middle segments 31, which are a portion near the central portion located at the central part of the bulb 21, may be made relatively higher than that of light from the end portion segments 34, which are end portions located at both side portions of the bulb 21, the farther the filament segments are from the central part of the bulb 21 in the diameter direction toward the outside thereof. The larger the pitch of the filament segments is the more possible it is to obtain the illuminance characteristics close to those of a point light source, which has a light distribution in which an illuminance of the central part of the light irradiation face is high and an illuminance therearound is low.

Moreover, since the length W of the filament formation area FA in a direction perpendicular to the axial direction of the bulb 21 is set at 90% or less of the inner diameter of the bulb 21 in size, it is possible to obtain a state where the filament 30 is not too close to the bulb 21 so that it is possible to prevent the temperature of the bulb 21 from rising locally at the lighting time. As a result, it is possible for a predetermined halogen cycle to certainly work, and when such a state is secured, the length H of the filament formation area FA in the axial direction of the bulb 21 is set an appropriate size, which is within a range in which the ratio (H/W) of the length H of the filament formation area FA in the axial direction of the bulb 21, to the length W in a direction perpendicular to the axial direction of the bulb 21 is 0.5 or more. Thus, since the formation area FA of the filament 30 can be configured in an approximately square and flat surface shape, a light distribution having an approximately circular shape can be obtained on the light irradiation face, so that it is possible to obtain the illuminance characteristics close to those of a point light source.

Furthermore, when the filament formation area FA is arranged so that there is some space between the formation area FA and the bulb 21, the first glass piece 24A and the second glass piece 24B, whose lengths in a direction perpendicular to the axial direction of the bulb 21 are longer than that of the filament formation area FA, can be arranged inside the bulb 21.

Therefore, according to the light source apparatus 10 having the above-mentioned incandescent bulb 20, when the incandescent bulb 20 is arranged in a direction extending along with the central axis L1 of the condensing mirror so that the two filament segments 31 located at the central part of the bulb 21 may sandwich the central axis L1 of the condensing mirror, since the condensing point of the condensing mirror 11 is located at a portion where the two middle filaments 31 of the filament 30 of the incandescent bulb 20 are located and from which the highest illuminance light is emitted, while the illuminance characteristics, which are substantially equal to the illuminance characteristics acquired by the light source apparatus which uses a point light source, can be obtained on the light irradiation face by the structure in which the incandescent bulb 20 according to the present invention is installed inside a common condensing mirror, the usage efficiency of light emitted from the incandescent bulb 20 can be improved. Thus, it can be configured to be suitable for a spot light source.

Experimental examples, which were performed to check the effects of the present invention, will be given in below.

### <Manufacturing Example 1 of Incandescent Bulb>

According to the structure shown in FIGS. 1-3, an incandescent bulb (hereinafter referred to as an “incandescent bulb 1”) was made.

The material of a bulb (21) was quartz glass and it had the outside diameter of 18 mm, the inner diameter of 15 mm and the overall length of 55 mm.

The number of filament segments of a filament (30) was eight (two middle segments (31), two inner side intermediate segments (32), two outer side intermediate segments (33), and two end portion segments (34)), and the specification of each filament segment and the entire filament (30) are shown below in Table 1.

In Table 1, the “pitch” is shown by a relative value wherein the pitch is taken as 100% when the size of the clearance (gap) between adjoining wires is 0. In addition, the size of clearance between adjoining wires of the middle segments (31) was 0.09 mm (=the wire diameter 0.19 mm×0.47), the size of clearance between wires of the inner side intermediate segment (32) was 0.10 mm, the size of clearance between wires of the outer side intermediate segment (33) was 0.12 mm, and the size of the clearance between wires of the end portion segment (34) was 0.14 mm.

The length (W) of a formation area (FA) of the filament (30) in a direction perpendicular to the tube axis of the bulb (21) was 60% of the inner diameter of the bulb (21) in size, and an aspect ratio (H/W) was 0.9.

### <Manufacturing Example 1 of Comparative Incandescent Bulb>

The incandescent bulb for comparison (hereinafter referred to as an “comparative incandescent bulb 1”) was made in which the structure was the same as that of the above-mentioned incandescent bulb 1, except that, as shown below in Table 1, the pitches of eight filament segments, that is, middle segments, inner side intermediate segments, outer side intermediate segments, and end portion segments, and design electric power, were the same as one another. The size of clearance between wires of each filament segment is 0.09 mm.

### <Manufacturing Example 2 of Incandescent Bulb>

An incandescent bulb (hereinafter referred to as an “incandescent bulb 2”) was made in which the structure was the same as that of the above-mentioned incandescent bulb 1, except that the number of filament segments was six (two middle segments, two intermediate segments, and two end portion segments), and the pitch of each filament segment and design electric power for each filament segment were changed according to Table 1 shown below. In addition, the size of clearance between wires of the middle segments was 0.09 mm, the size of clearance between wires of the intermediate segments was 0.12 mm and the size of clearance between the wires of the end portion segments was 0.15 mm.

TABLE 1

| | Filament | | | | | | | | |
|---|---|---|---|---|---|---|---|---|---|
| | | | | | | | | Size | |
| | | | | | | | | (formation | |
| | | | Wire | | | Pitch | Design | area) [W | |
| | | | diameter | Length | Pitch | ratio | power | (mm) × H | |
| | Segments | | [mm] | [mm] | [%] | [%] | [W] | (mm)] | Input Power [W] |
| Incandescent | 8 | Middle (2) | 0.19 | 8 | 147 | 100 | 69 | 9 × 8 | 575 |
| bulb 1 | | Inner side | 0.19 | 8 | 155 | 95 | 71 | (H/W = 0.9) | |
| | | intermediate (2) | | | | | | | |
| | | Outer side | 0.19 | 8 | 163 | 90 | 73 | | |
| | | intermediate (2) | | | | | | | |
| | | End portion (2) | 0.19 | 8 | 172 | 85 | 75 | | |
| Comparative | 8 | Middle (2) | 0.19 | 8 | 159 | 100 | 72 | 9 × 8 | 575 |
| incandescent | | Inner side | 0.19 | 8 | 159 | 100 | 72 | (H/W = 0.9) | |
| bulb 1 | | intermediate (2) | | | | | | | |
| | | Outer side | 0.19 | 8 | 159 | 100 | 72 | | |
| | | intermediate (2) | | | | | | | |
| | | End portion (2) | 0.19 | 8 | 159 | 100 | 72 | | |
| Incandescent | 6 | Middle (2) | 0.19 | 13.5 | 147 | 100 | 90 | 13.5 × 5.5 | 575 |
| bulb 2 | | Intermediate (2) | 0.19 | 13.5 | 162 | 91 | 96 | (H/W = 0.4) | |
| | | End portion (2) | 0.19 | 13.5 | 180 | 82 | 102 | | |

Each of the incandescent bulb 1, the comparative incandescent bulb 1, and the incandescent bulb 2 were respectively installed in the paraboloidal surface condensing mirrors having an opening diameter of 120 mm and a depth of 90 mm producing light source apparatuses referring to the structure of FIG. 1, and a lighting test shown below was performed.

### <Lighting Test>

An area of 1 meter long and 1 meter wide is set as a light irradiation face at a position where a separation distance from an opening edge of the paraboloidal surface condensing mirror in a direction of a central axis of the condensing mirror was 5 m, and each incandescent bulb was turned on condition that input power was 575 W, and while the illuminance at center of the irradiation spot formed on the light irradiation face was measured, the usage efficiency of light emitted from the incandescent bulb was measured. A result is shown in table 2 below. The “illuminance at center” is shown in Table 2 by a relative value [%] with respect to the illuminance at center, which was obtained in the light source apparatus concerning the comparative incandescent bulb 1. Moreover, the “usage efficiency of light” is a value represented by a ratio of light flux on the light irradiation face to all light flux of only the incandescent bulb [(light flux on the light irradiation face)/(all light flux)], and is shown by a relative value [%] with respect to the usage efficiency of light obtained in the light source apparatus concerning the comparative incandescent bulb 1.

TABLE 2

| | | Illuminance at | |
|---|---|---|---|
| | Filament | center on a light | Usage |
| | size | irradiation face | efficiency |
| | [W (mm) × | (relative value) | of light (relative |
| | H (mm)] | [%] | value) [%] |
| Incandescent bulb 1 | 9 × 8 | 107 | 113 |
| | (H/W = 0.9) | | |
| Comparative | 9 × 8 | 100 | 100 |
| incandescent bulb 1 | (H/W = 0.9) | | |
| Incandescent bulb 2 | 13.5 × 5.5 | 95 | 97 |
| | (H/W = 0.4) | | |

As is evident from the above result, in the incandescent bulb 1 having the filament in which while the pitch of the middle segments located at the central part of the bulb was set to the smallest value, the farther the filament segments are from the central part of the bulb toward the outsides in a diameter direction the greater the pitch thereof is. It was also found that it was possible to obtain light distribution with central illuminance on the light irradiation face, which was higher than that of the comparative incandescent bulb 1 if the input electric power was the same, as the usage efficiency of light became high and improved, for example, by even 13% specifically in the incandescent bulb having the above-mentioned structure. Moreover, in relation to the result in the light source apparatus concerning the incandescent bulb 2, since the filament formation area was formed in an approximately square and flat shape, it was found that in the incandescent bulb 1, it was possible to certainly obtain the above-mentioned result.

### DESCRIPTION OF REFERENCE NUMBERS

10 Light source apparatus
11 Condensing mirror
12 Reflective face
20 Incandescent bulb
21 Bulb
21A Exhaust pipe remaining portion
22 Sealing portion
23 Internal lead
24A First glass piece
24B Second glass piece
25 Anchor
26 Supporter
28 Mouthpiece insulator
29 Connection terminal
30 Filament
31 Middle segment (filament segment)
32 Inner side intermediate segment (filament Segment)
33 Outer side intermediate segment (filament segment)
34 End portion segment (Filament segment)
35 Connecting portion
38 Single wire section (connecting portion)
40 Light source apparatus
41 Incandescent bulb
42 Filament
42A filament segment
43 Bulb
44 Mouthpiece insulator
45 Lens
48 Reflection mirror
C1 Tube axis of a bulb (central axis of an incandescent bulb)
C2 Tube axis of a bulb (central axis of an incandescent bulb)
L1 Central axis of a condensing mirror (optical axis)
L2 Central axis of a lens (optical axis)
L3 Central axis of a reflection mirror (optical axis)
P1 Pitch of middle segments
P2 Pitch of inner side intermediate segments
P3 Pitch of outer side intermediate segments
P4 Pitch of end portion segments
d Distance between the central axes of filament segments
FA Filament formation area

1. An incandescent bulb comprising:
a filament of incandescent bulb that comprise a plurality of filament segments made from a single coil formed by winding one wire material that respectively extend along an axial direction of the bulb and are arranged in parallel to form a flat surface,
wherein a pitch of a plurality of filament segments located at a central part of the bulb is smaller than a pitch of a plurality of filament segments located at a first side portion and a second side portion.

2. The incandescent bulb according to claim 1, wherein a length of a filament formation area in a direction perpendicular to an axial direction of the incandescent bulb is 90% or less of an inner diameter of the incandescent bulb.

3. The incandescent bulb according to claim 2, wherein a ratio H/W of a length H of the filament formation area in the axial direction of the incandescent bulb to a length W of the filament formation area in a direction perpendicular to the axial direction of the incandescent bulb is 0.5 or more.

4. A light source apparatus comprising:
the incandescent bulb according to claim 1, and
a condensing mirror,
wherein the incandescent bulb is arranged in a direction extending along with a central axis of the condensing mirror so that two of the filament segments located at the central part of the bulb are located so as to sandwich the central axis of the condensing mirror.

5. A light source apparatus comprising:
the incandescent bulb according to claim 2, and
a condensing mirror,
wherein the incandescent bulb is arranged in a direction extending along with a central axis of the condensing mirror so that two of the filament segments located at the central part of the bulb are located so as to sandwich the central axis of the condensing mirror.

6. A light source apparatus comprising:
the incandescent bulb according to claim 3, and
a condensing mirror,
wherein the incandescent bulb is arranged in a direction extending along with a central axis of the condensing mirror so that two of the filament segments located at the central part of the bulb are located so as to sandwich the central axis of the condensing mirror.
